(19) United States
(12) Patent Application Publication
(10) Pub. No.: US 2025/0184808 A1
(43) Pub. Date: Jun. 5, 2025

(54) GEOLOCATION-BASED APPLICATIONS USING 3GPP SIDELINK

(71) Applicant: T-Mobile USA, Inc., Bellevue, WA (US)

(72) Inventor: Chad Au, Kirkland, WA (US)

(21) Appl. No.: 18/528,254

(22) Filed: Dec. 4, 2023

(51) Int. Cl. H04W 28/02; H04W 72/40; H04W 76/14

(52) U.S. Cl. CPC H04W 28/0226; H04W 72/40; H04W 76/14

(57) ABSTRACT

Techniques and architecture discussed herein describe applications (apps) that allow devices, e.g., mobile devices such as smartphones, tablets, etc., that are out of wireless network coverage to communicate or coordinate with other mobile devices within detectable range, in essence forming a local area network (LAN), by exploiting the Third Generation Partnership Project (3GPP) sidelink feature and geolocation capabilities of the mobile devices. Teams of users may spread out over a specified area and be informed about team members' locations relative to theirs, as well as their up-to-the-minute status or other inputs. More particularly, the 3GPP standard has an “off-network” feature called “sidelink” that can facilitate device-to-device communication without the need for a network connection, e.g., the mobile devices may function similar to walkie talkies.

### BACKGROUND

With smartphones having become extremely popular, there are arguably infinite possibilities for their application given their rich feature set. While there are numerous smartphone applications already available that exploit the ability to access information over a wireless network connection, there are incidences where a wireless network connection is not available (such as, for example, remote locations with no coverage) but communication is needed between smartphone users and/or smartphones in a coordinated fashion based on each of their locations. Unlike most applications today that make use of their wireless network connection to function, smartphones operating out of coverage are not able to benefit from the wireless network, especially if the smartphones need to communicate and coordinate efforts with other users and/or smartphones.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1A schematically illustrates an example arrangement that includes a wireless communication network and terrain that does not have wireless communication network coverage, in accordance with various configurations.

FIGS. 1B-1E schematically illustrate the example arrangement of FIG. 1A including grid arrangements, in accordance with various configurations.

FIG. 2 is a flow diagram of an example process for allowing mobile devices that are out of wireless network coverage, e.g., that are in the terrain of the example arrangements of FIGS. 1A-1C, to communicate or coordinate with other mobile devices within detectable range, in accordance with various configurations.

FIG. 3 schematically illustrates a component level view of an example electronic device configured for use with the arrangements of FIGS. 1A-1C, in accordance with various configurations.

### DETAILED DESCRIPTION

Techniques and architecture are described herein describe applications (apps) that allow devices, e.g., mobile devices such as smartphones, tablets, etc., that are out of wireless network coverage to communicate or coordinate with other mobile devices within detectable range, in essence forming a local area network (LAN), by exploiting the Third Generation Partnership Project (3GPP) sidelink feature and geolocation capabilities of the mobile devices. Teams of users may spread out over a specified area and be informed about team members' locations relative to theirs, as well as their up-to-the-minute status or other inputs. More particularly, the 3GPP standard has an “off-network” feature called “sidelink” that can facilitate device-to-device communication without the need for a network connection, e.g., the mobile devices may function similar to walkie talkies. In essence, a local area network among mobile devices within their sidelink communication range may be formed. In conjunction with most mobile devices having the capability to determine geolocation, applications may be implemented that utilize such features.

For example, in an embodiment, an application may be designed for search-and-rescue efforts to locate lost individual(s) to aid first responders with systematic searches of a target area by a team of first responders spread out over terrain and communicate with communication signals via mobile devices using the sidelink feature during a mission. The sidelink feature provides a direct communication link between the mobile devices and the communication signals may be in the form of voice signals or text signals. In an example, the terrain may be defined by a grid pattern, which informs on the location of each responder. Most mobile devices have global positioning satellite (GPS)/geolocation capabilities. Thus, use of the grid may help the responders avoid getting lost. The use of the grid may also mark boundaries for each team member to provide a reference for the responders to search within their assigned area. Information may be exchanged among the locally networked mobile devices on status of the search-and-rescue efforts, or to conclude the search if the individual(s) is/are found.

As another example, in another embodiment, an application may be designed to allow a team of archaeologists in a field survey of a lost city (or other discovered ancient site) to coordinate their efforts when gathering artifacts or making observations and communicate with communication signals via the mobile devices using the sidelink feature during a mission. The sidelink feature provides a direct communication link between the mobile devices and the communication signals may be in the form of voice signals or text signals. Teamwork in such a way may recognize patterns of the ancient civilization under study more quickly if team members at the site are able to coordinate gathered information in real time. In an example, the lost city (or other discovered ancient site) may be defined by a grid pattern, which informs on the location of each archaeologist. As previously noted, most mobile devices have GPS/geolocation capabilities. Thus, use of a grid may help the archaeologists avoid getting lost. The use of the grid may also mark boundaries for each team member to provide a reference for the archaeologists to explore/search within their assigned area.

In another embodiment, an application may allow the monitoring of conditions over an area where one or more mobile devices are connected to one or more sensor(s) and relay that information to one or more user(s) and/or one or more other mobile device(s), providing detailed awareness of the situation being monitored. Use of a grid may help with placement of sensor(s) and help ensure all desired areas have at least one sensor. The sensor(s) may be physically coupled to the mobile device(s) and/or may be wirelessly coupled to the mobile device(s).

In another embodiment, a team of soldiers may coordinate their movements during a mission and communicate with communication signals via the mobile devices using the sidelink feature during a mission. The sidelink feature provides a direct communication link between the mobile devices and the communication signals may be in the form of voice signals or text signals. For example, the team of soldiers may be combing through an area over some distance, where wireless network coverage is inconsistent or even non-existent. An application may provide a commanding officer greater situational awareness of his/her team members' location for greater cohesion, as well as reducing the chance of friendly fire if the situation becomes chaotic. In an example, the mission may be defined by a grid pattern over a particular area, which informs on the location of each soldier. As previously noted, most mobile devices have GPS/geolocation capabilities. Thus, use of a grid may help the soldiers avoid getting lost. The use of the grid may also mark boundaries for each soldier to provide a reference for the soldier to move, search, etc. (depending on the mission) within their assigned area.

In embodiments, there may be a hierarchy of roles or priority of cells/mobile devices within the grid/area. This may make coordinating among the users in the area more efficient and/or purposeful.

In embodiments, the applications may need to use mobile devices in a “daisy chain” fashion. For example, a first mobile device may not be able to communicate with a second mobile device due to range, line of sight, etc. Thus, the first mobile device may communicate with a third mobile device, which may pass along the communication from the first mobile device to the second device. In embodiments, more than one mobile device may be needed to pass along the communication from the first mobile device to the second mobile device. Additionally, users of the intermediate mobile device(s) may or may not be made aware of the passing along of communications between the first mobile device and the second mobile device. Thus, in embodiments, users of mobile devices may need to opt-in through an application for allowing their mobile device to be used as an intermediate mobile device in a daisy chain arrangement.

In embodiments, the applications may determine which mobile devices to use in the daisy chain arrangement. For example, an application may choose mobile devices based on one or more of signal strength, line of sight, shortest number of hops, etc.

In embodiments, a developer of an application may have a list of participants. In some embodiments, participants may or may not need to provide their permission for their mobile devices to operate in an LAN defined by an application. In some embodiments, participants may not know they are participating. In embodiments, a participant may opt out, e.g., their mobile device may be invisible to other participants' mobile device. The opt-out may be an entire opt out or may be intermittent, e.g., the participant may opt out for a period of time and then opt back in.

In embodiments, one or more mobile devices may have a connection with a wireless communication network, e.g., such mobile devices may be within, but on the edge of, wireless communication network coverage. Thus, such mobile devices may be used to provide communications from the mobile devices of team members that are without wireless communication network coverage to the wireless communication network and thereby mobile devices (or other devices) within the wireless communication network, and vice versa. For example, a member of a team may be on a hill where wireless communication network coverage is available while other members of the team are in a valley where wireless communication network coverage is not available. Thus, the team member on the hill may be used to extend wireless communication network coverage to the mobile devices in the valley by communicating with the mobile devices in the valley via an application and sidelink features and communicating with the wireless communication network and thereby mobile devices (or other devices) within the wireless communication network.

In embodiments, the grid pattern may be dynamically defined in shape or size, up to the sidelink budget limit of the mobile devices and allowed by the terrain. In some embodiments, the grid pattern may be selected as desired to suit the task at hand. Not all applications that use sidelink and GPS/geolocation capabilities of mobile devices require a grid. For example, applications in situations where the users are meant to be mobile over some distance, e.g., the example described above involving soldiers, grids may not be needed. In such incidences, the application may report on the location of each mobile device and provide their positions relative to one another on a map.

Accordingly, for example, in embodiments a method comprises determining, by an application on at least a first device of a plurality of devices, a geographical location that includes the plurality of devices, wherein each of the plurality of devices is configured to operate within a wireless communication network. The method also comprises based at least in part on the geographical location, defining, by the application, a local area network (LAN) of the plurality of devices, wherein the LAN provides direct communication links among at least some of the plurality of devices. The method further comprises establishing, by the application, a first communication link between the first device and a second device of the plurality of devices, wherein the first device and the second device are configured to operate within the wireless communication network, and wherein the first communication link is a direct communication link between the first device and the second device. The method additionally comprises sending, by the application, a communication signal over the first communication link from the first device to the second device.

In some embodiments, users of at least some devices of the plurality of devices are part of a search and rescue team operating within an area in which the wireless communication network is inoperable.

In some embodiments, users of at least some devices of the plurality of devices are archeologists operating within an area in which the wireless communication network is inoperable.

In some embodiments, users of at least some devices of the plurality of devices are soldiers operating within an area in which the wireless communication network is inoperable.

In some embodiments, the second device includes the application and the method further comprises establishing, by the application on the second device, a second communication link with a third device of the plurality of devices, wherein the third device is configured to operate within the wireless communication network, and wherein the second communication link is a direct communication link between the second device and the third device, and the method further comprises forwarding, by the application, the communication signal over the second communication link from the second device to the third device.

In some embodiments, the communication signal comprises data from a sensor coupled to the first device.

In some embodiments, the communication signal is a voice signal.

In some embodiments, the communication signal is a text signal.

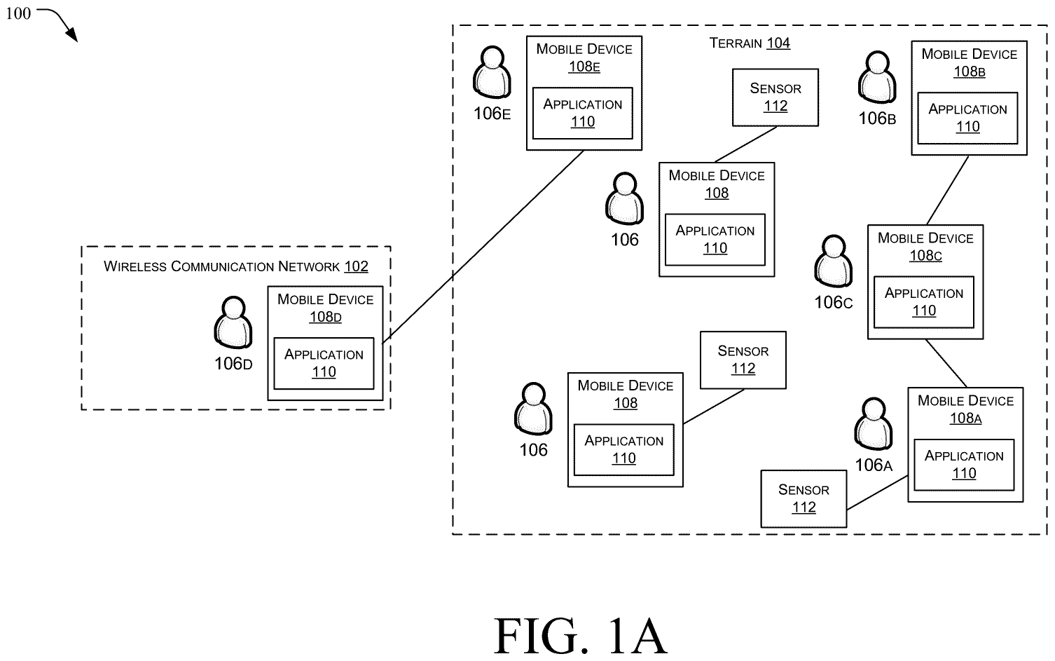

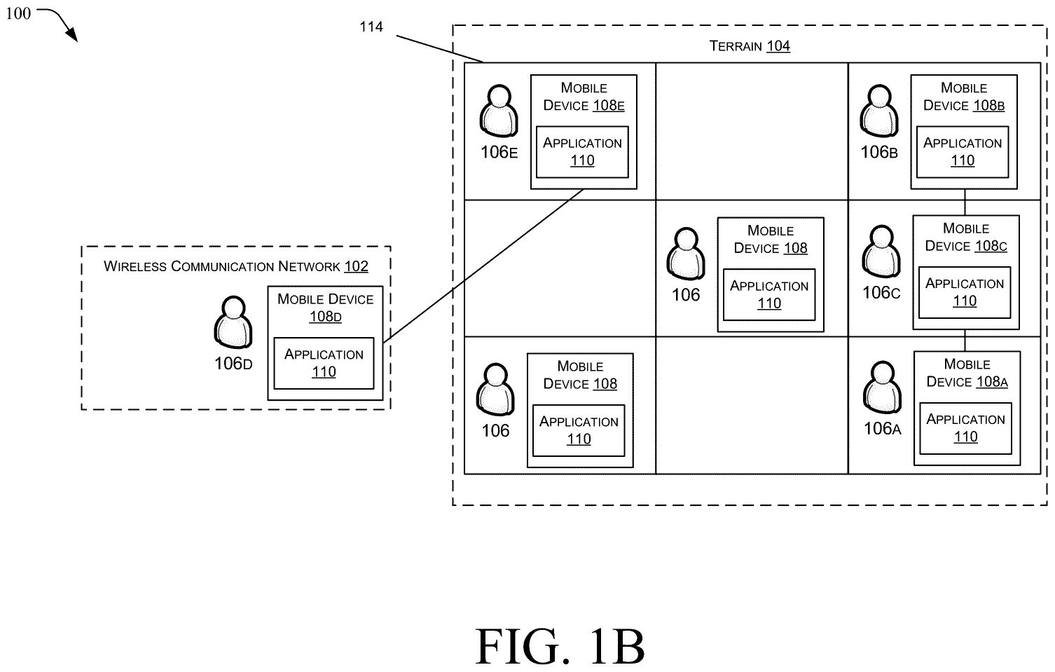

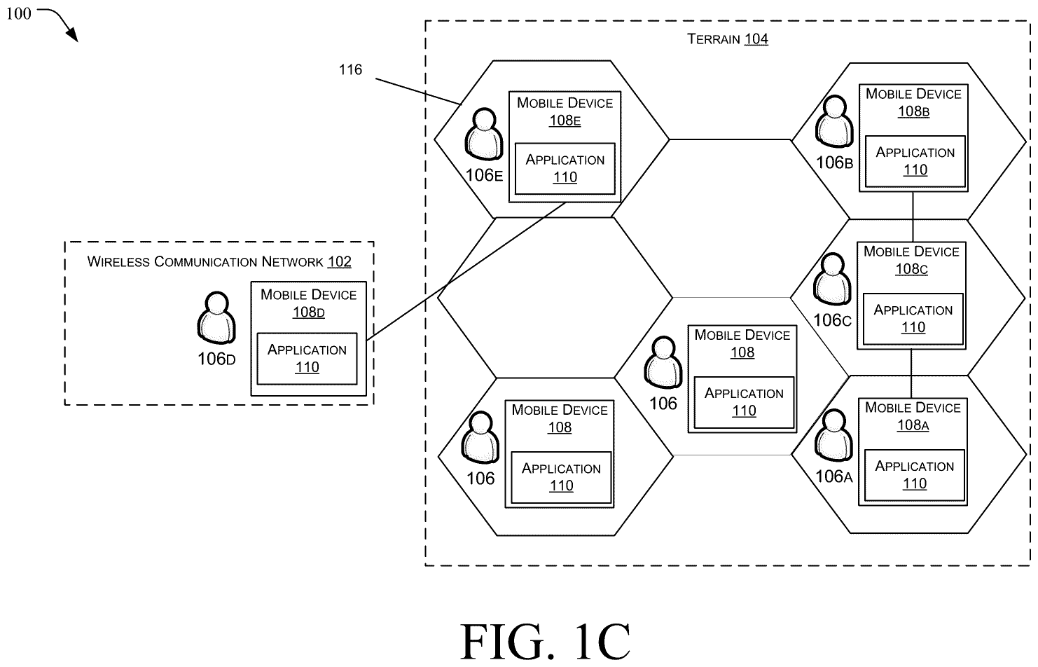

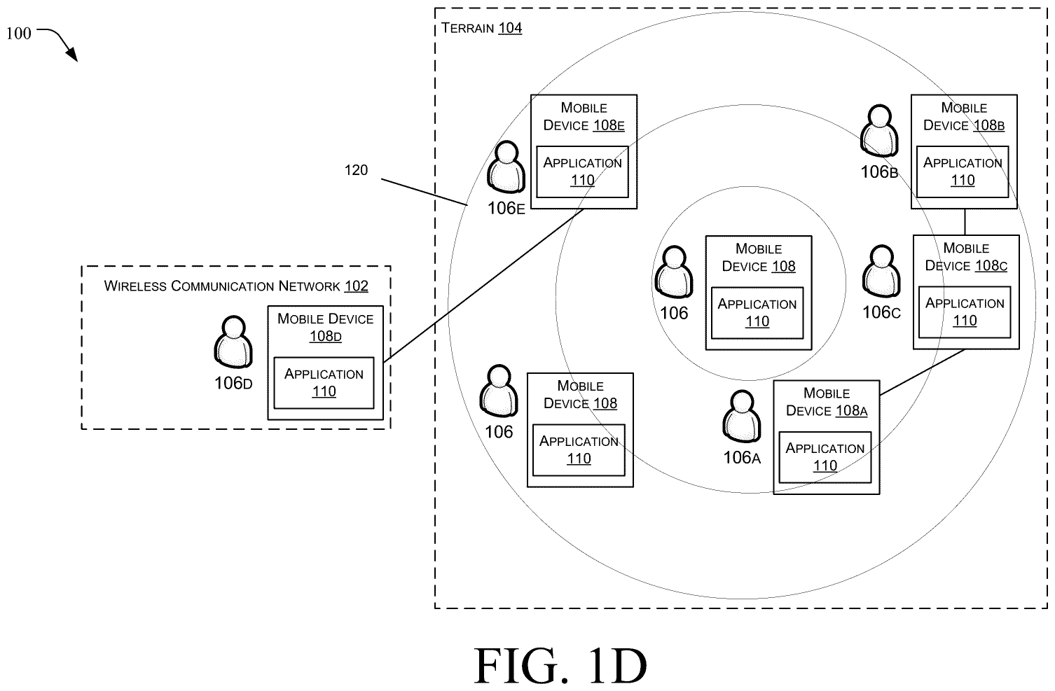

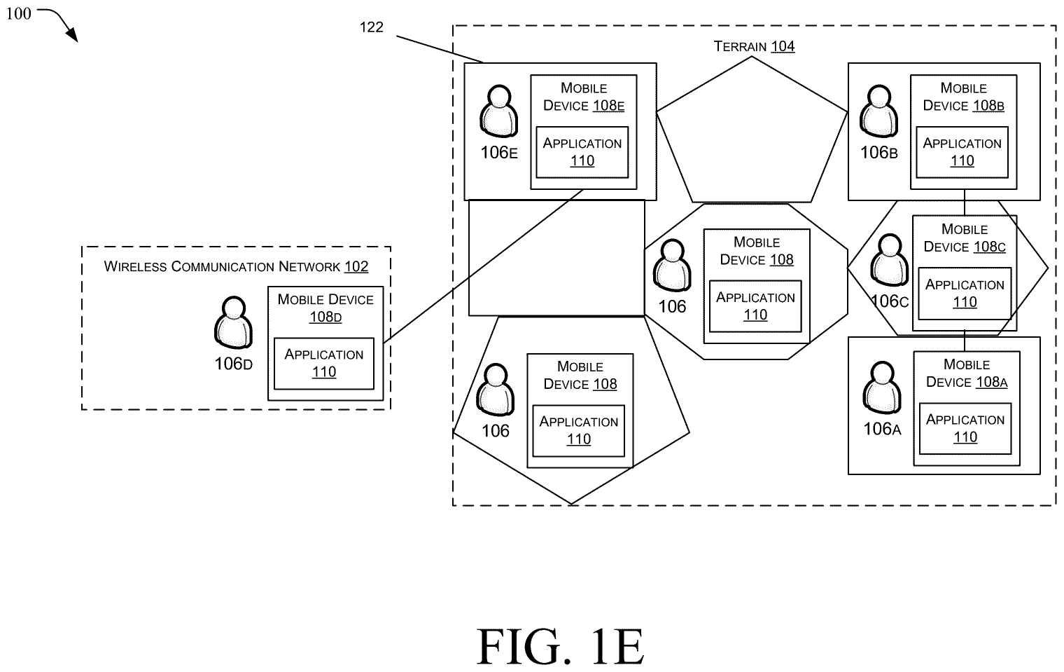

FIG. 1A schematically illustrates an example arrangement 100 that includes a wireless communication network 102 and terrain 104 that does not have wireless communication network coverage. The example arrangement 100 includes a plurality of users 106 and their mobile devices 108 such as, for example, smartphones, tablets, etc. One or more of the mobile devices 108 include an application 110 that is configured to allow the mobile devices 108 that are out of wireless network coverage of wireless communication network 102 to communicate or coordinate with other mobile devices 108 within detectable range, in essence forming a local area network (LAN), by exploiting the Third Generation Partnership Project (3GPP) sidelink feature and geolocation capabilities of the mobile devices 108.

In an embodiment, at least some of the users 106 are first responders. The application 110 may be designed for search-and-rescue efforts to locate lost individual(s) to aid first responders (users 106) with systematic searches of the terrain 104 by a team of first responders (users 106) spread out over the terrain 104 and communicate with communication signals via the mobile devices 108 using the sidelink feature. The sidelink feature provides a direct communication link between the mobile devices 108 and the communication signals may be in the form of voice signals or text signals. In an example, the terrain 104 may be defined by a grid pattern, which informs on the location of each responder (user 106). Most mobile devices 108 have global positioning satellite (GPS)/geolocation capabilities. Thus, use of the grid may help the responders avoid getting lost. The use of the grid may also mark boundaries for each team member to provide a reference for the responders to search within their assigned area. Information may be exchanged among the locally networked mobile devices 108 on status of the search-and-rescue efforts, or to conclude the search if the individual(s) is/are found.

As another example, in another embodiment, at least some of the users 106 are archeologists and the application 110 may be designed to allow a team of archaeologists (users 106) in a field survey of a lost city (or other discovered ancient site) to coordinate their efforts and communicate with communication signals via the mobile devices 108 using the sidelink feature when gathering artifacts or making observations. The sidelink feature provides a direct communication link between the mobile devices 108 and the communication signals may be in the form of voice signals or text signals. Teamwork in such a way may recognize patterns of the ancient civilization under study more quickly if team members (users 106) at the site are able to coordinate gathered information in real time. In an example, the lost city (or other discovered ancient site) may be defined by a grid pattern, which informs on the location of each archaeologist (user 106). As previously noted, most mobile devices 108 have GPS/geolocation capabilities. Thus, use of a grid may help the archaeologists (users 106) avoid getting lost. The use of the grid may also mark boundaries for each team member (user 106) to provide a reference for the archaeologists to explore/search within their assigned area.

In another embodiment, the application 110 may be designed to allow the monitoring of conditions over an area, e.g., terrain 104, where one or more mobile devices 108 are connected to one or more sensor(s) 112 and relay that information to one or more user(s) 106 and/or one or more other mobile device(s) 108, providing detailed awareness of the situation being monitored. Use of a grid may help with placement of sensor(s) 112 and help ensure all desired areas have at least one sensors 112. The sensor(s) may be physically coupled to the mobile device(s) 108 and/or may be wirelessly coupled to the mobile device(s) 108.

In another embodiment, at least some of the users 106 are soldiers. The application 110 may be designed such that a team of soldiers (users 106) may coordinate their movements and communicate with communication signals via the mobile devices 108 using the sidelink feature during a mission. The sidelink feature provides a direct communication link between the mobile devices 108 and the communication signals may be in the form of voice signals or text signals. For example, the team of soldiers (users 106) may be combing through an area over some distance, where connection with the wireless communication network 102 is inconsistent or even non-existent. The application 110 may provide a commanding officer greater situational awareness of his/her team members' location for greater cohesion, as well as reducing the chance of friendly fire if the situation becomes chaotic. In an example, the mission may be defined by a grid pattern over a particular area, which informs on the location of each soldier (user 106). As previously noted, most mobile devices 108 have GPS/geolocation capabilities. Thus, use of a grid may help the soldiers (users) avoid getting lost. The use of the grid may also mark boundaries for each soldier to provide a reference for the soldier to move, search, etc. (depending on the mission) within their assigned area.

In embodiments, there may be a hierarchy of roles or priority of cells within the grids 114-122 and/or mobile devices 108 within the grid/area. This may make coordinating among the users 106 in the area more efficient and/or purposeful.

In embodiments, the application 110 may need to use mobile devices 108 in a “daisy chain” fashion. For example, a first mobile device 108a may not be able to communicate with a second mobile device 108b due to range, line of sight, etc. Thus, the first mobile device 108a may communicate with a third mobile device 108c, which may pass along the communication from the first mobile device 108a to the second mobile device 108b. In embodiments, more than one mobile device 108 may be needed to pass along the communication from the first mobile device 198a to the second mobile device 108b. Additionally, users 106 of the intermediate mobile device(s) 108 may or may not be made aware of the passing along of communications between the first mobile device 108a and the second mobile device 108b. Thus, in embodiments, users 106 of mobile devices 108 may need to opt-in through the application 110 for allowing their mobile device 108 to be used as an intermediate mobile device 108 in a daisy chain arrangement.

In embodiments, the application 110 may determine which mobile devices 108 to use in the daisy chain arrangement. For example, the application 110 may choose mobile devices 108 based on one or more of signal strength, line of sight, shortest number of hops, etc.

In embodiments, a developer of the application 110 may have a list of participants, e.g., users 106. In some embodiments, participants may or may not need to provide their permission for their mobile devices 108 to operate in an LAN defined by the application 110. In some embodiments, participants may not know they are participating. In embodiments, a participant may opt out, e.g., their mobile device may be invisible to other participants' mobile device. The opt-out may be an entire opt out or may be intermittent, e.g., the participant may opt out for a period of time and then opt back in.

In embodiments, one or more mobile devices 108 may have a connection with the wireless communication network 102, e.g., such mobile devices 108 may be within, but on the edge of, wireless communication network 102 coverage. For example, user 106d and mobile device 108d have wireless communication network 102 coverage. Thus, mobile device 108d may be used to provide communications from the mobile devices 108 of users 106 that are within terrain 104 and without wireless communication network coverage to the wireless communication network 102 and thereby mobile devices (or other devices) within the wireless communication network 102, and vice versa. For example, user 106d may be on a hill where wireless communication network 102 coverage is available while other users 106 are in a valley, e.g., terrain 104, where wireless communication network 102 coverage is not available. Thus, the user 106d on the hill may be used to extend wireless communication network 102 coverage to one or more of the mobile devices 108 in the valley (terrain 104) by communicating with one or more of the mobile devices 108 (e.g., mobile device 108e of user 106e) in the valley (terrain 104) via the application 110 and sidelink features and communicating with the wireless communication network 102 and thereby mobile devices (or other devices) within the wireless communication network 102.

In embodiments, a grid pattern may be dynamically defined in shape or size, up to the sidelink budget limit of the mobile devices and allowed by the terrain. FIG. 1B illustrates the example arrangement 100 including a grid pattern 114 made up of rectangles. FIG. 1C illustrates the example arrangement 100 including a grid pattern 116 made up of hexagons. While FIGS. 1B and 1C illustrate the grid pattern as having a regular pattern and shape, in embodiments grid patterns having varying patterns and/or shapes may also be used. For example, FIG. 1D illustrates the example arrangement 100 including a grid pattern 118 made up of concentric circles. In embodiments, the circles of the grid pattern 120 may be made up of circles having varying radii. FIG. 1E illustrates the example arrangement 100 including a grid pattern 122 made up of random polygons of variable sizes. In some embodiments, the grid pattern may be selected as desired to suit the task at hand. Not all applications that use sidelink and GPS/geolocation capabilities of mobile devices require a grid. For example, applications in situations where the users are meant to be mobile over some distance, e.g., the example described above involving soldiers, grids may not be needed. In such incidences, the application may report on the location of each mobile device and provide their positions relative to one another on a map.

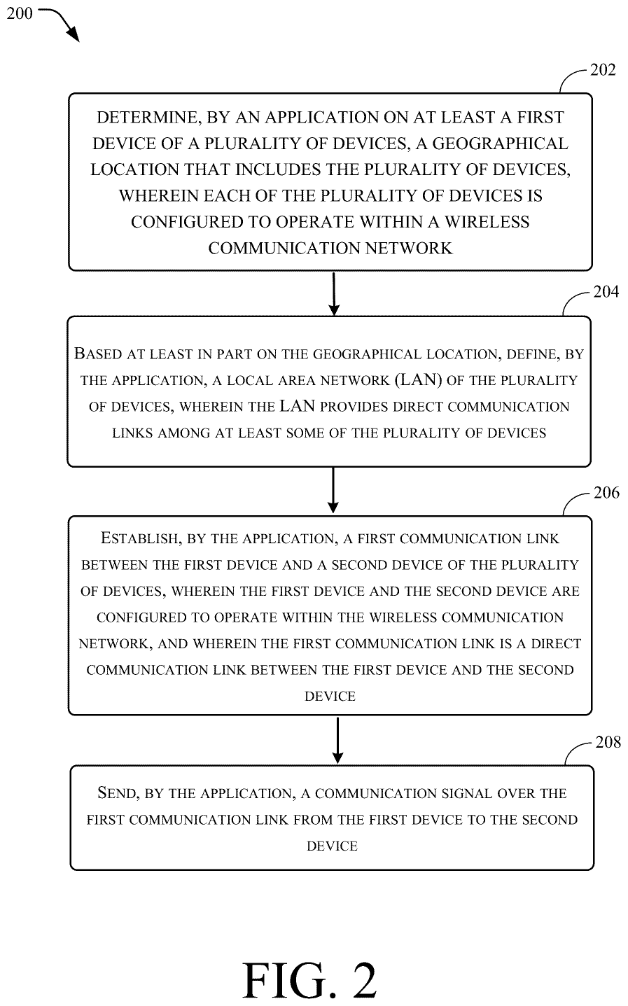

FIG. 2 is a flow diagram of an illustrative process that may be implemented within or in association with the examples of FIGS. 1A-1C. This process (as well as other processes described throughout) is illustrated as a logical flow graph, each operation of which represents a sequence of operations that can be implemented in hardware, software, or a combination thereof. In the context of software, the operations represent computer-executable instructions stored on one or more tangible computer-readable storage media that, when executed by one or more processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Furthermore, while the architectures and techniques described herein have been described with respect to wireless networks, the architectures and techniques are equally applicable to processor(s) and processing cores in other environments and computing devices.

FIG. 2 is a flow diagram of an example process 200 for allowing mobile devices, e.g., mobile devices 108, that are out of wireless network coverage to communicate or coordinate with other mobile devices within detectable range, in essence forming a local area network (LAN), by exploiting the Third Generation Partnership Project (3GPP) sidelink feature and geolocation capabilities of the mobile devices.

At 202, in embodiments, an application on at least a first device of a plurality of devices determines a geographical location that includes the plurality of devices, wherein each of the plurality of devices is configured to operate within a wireless communication network. At 204, in embodiments, based at least in part on the geographical location, the application defines a local area network (LAN) of the plurality of devices, wherein the LAN provides direct communication links among at least some of the plurality of devices. For example, the example arrangement 100 includes a wireless communication network 102 and terrain 104 that does not have wireless communication network coverage. The example arrangement 100 includes a plurality of users 106 and their mobile devices 108 such as, for example, smartphones, tablets, etc. One or more of the mobile devices 108 include an application 110 that is configured to allow the mobile devices 108 that are out of wireless network coverage of wireless communication network 102 to communicate or coordinate with other mobile devices 108 within detectable range, in essence forming a local area network (LAN), by exploiting the Third Generation Partnership Project (3GPP) sidelink feature and geolocation capabilities of the mobile devices 108

At 206, in embodiments the application establishes a first communication link between the first device and a second device of the plurality of devices, wherein the first device and the second device are configured to operate within the wireless communication network, and wherein the first communication link is a direct communication link between the first device and the second device. At 208, in embodiments the application sends a communication signal over the first communication link from the first device to the second device. For example, in an embodiment, at least some of the users 106 are first responders. The application 110 may be designed for search-and-rescue efforts to locate lost individual(s) to aid first responders (users 106) with systematic searches of the terrain 104 by a team of first responders (users 106) spread out over the terrain 104 and communicate with communication signals via the mobile devices 108 using the sidelink feature. The sidelink feature provides a direct communication link between the mobile devices 108 and the communication signals may be in the form of voice signals or text signals. In an example, the terrain 104 may be defined by a grid pattern, which informs on the location of each responder (user 106). Most mobile devices 108 have global positioning satellite (GPS)/geolocation capabilities. Thus, use of the grid may help the responders avoid getting lost. The use of the grid may also mark boundaries for each team member to provide a reference for the responders to search within their assigned area. Information may be exchanged among the locally networked mobile devices 108 on status of the search-and-rescue efforts, or to conclude the search if the individual(s) is/are found.

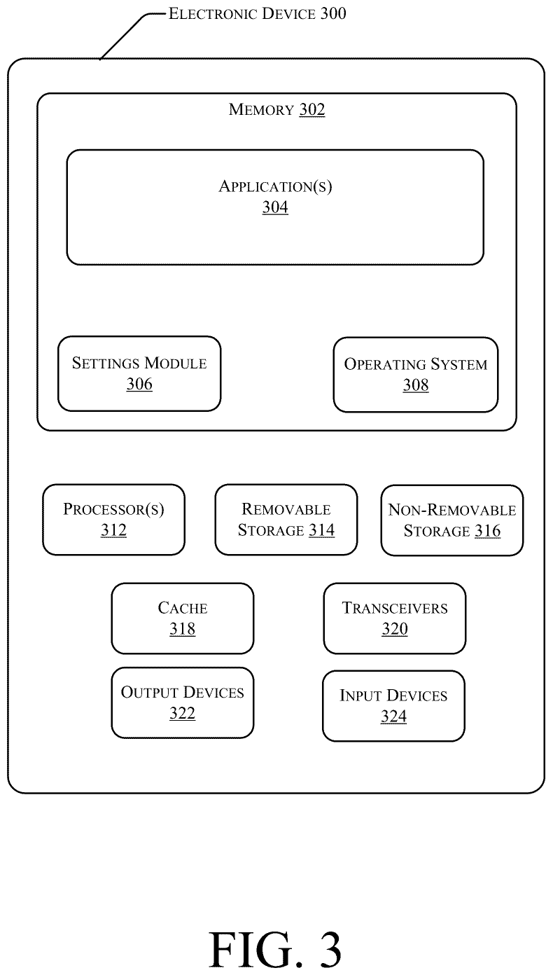

FIG. 3 schematically illustrates a component level view of an apparatus in the form of an example electronic device 300 that may be used to implement, for example, mobile devices 108. The electronic device 300 may include more or less components depending on the type of electronic device. As illustrated, the electronic device 300 comprises a system memory 302, e.g., computer-readable media, storing application(s) 304, e.g., application 110. For example, the system memory 302 may include one or more application(s) (app(s)) 304 configured to implement one or more functions with respect to the processes described herein. The mobile device also comprises a settings module 306, and an operating system 308. Also, the electronic device 300 includes processor(s) 312, a removable storage 314, a non-removable storage 316, cache 318, transceivers 320, output device(s) 322, and input device(s) 324. In various implementations, system memory 302 is volatile (such as RAM), non-volatile (such as ROM, flash memory, etc.) or some combination of the two. In some implementations, the processor(s) 312 is a central processing unit (CPU), a graphics processing unit (GPU), or both CPU and GPU, or any other sort of processing unit.

The electronic device 300 may also include additional data storage devices (removable and/or non-removable) such as, for example, magnetic disks, optical disks, or tape. Such additional data storage may include removable storage 314 and non-removable storage 316. Additionally, the electronic device 300 includes cache 318.

Non-transitory computer-readable media may include volatile and nonvolatile, removable and non-removable tangible, physical media implemented in technology for storage of information, such as computer readable instructions, data structures, program modules, or other data. System memory 302, removable storage 314, non-removable storage 316 and cache 318 are all examples of non-transitory computer-readable media. Non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information and which can be accessed by the electronic device 300. Any such non-transitory computer-readable media may be part of the electronic device 300. The processor(s) 312 may be configured to execute instructions, which may be stored in the non-transitory computer-readable media or in other computer-readable media accessible to the processor(s) 312.

In some implementations, the transceivers 320 include any sort of transceivers known in the art. For example, the transceivers 320 may include a radio transceiver that performs the function of transmitting and receiving radio frequency communications via an antenna (not shown). Also, or alternatively, the transceivers 320 may include wireless modem(s) to facilitate wireless connectivity with other computing devices. Further, the transceivers 320 may include wired communication components, such as an Ethernet port, for communicating with other networked devices.

In some implementations, the output devices 322 include any sort of output devices known in the art, such as a display (e.g., a liquid crystal display), speakers, a vibrating mechanism, or a tactile feedback mechanism. Output devices 322 also include ports for one or more peripheral devices, such as headphones, peripheral speakers, or a peripheral display.

In various implementations, input devices 324 include any sort of input devices known in the art. For example, input devices 324 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 324 may be used to enter preferences of a user of the electronic device 300 to define how the user wishes certain calls from third parties to be handled by the wireless communication network, as previously described herein.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Memory 302 is an example of computer storage media.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may various perform operations. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
determining, by an application on at least a first device of a plurality of devices, a geographical location that includes the plurality of devices, wherein each of the plurality of devices is configured to operate within a wireless communication network;
based at least in part on the geographical location, defining, by the application, a local area network (LAN) of the plurality of devices, wherein the LAN provides direct communication links among at least some of the plurality of devices;
establishing, by the application, a first communication link between the first device and a second device of the plurality of devices, wherein the first device and the second device are configured to operate within the wireless communication network, and wherein the first communication link is a direct communication link between the first device and the second device; and
sending, by the application, a communication signal over the first communication link from the first device to the second device.

2. The method of claim 1, wherein users of at least some devices of the plurality of devices are part of a search and rescue team operating within an area in which the wireless communication network is inoperable.

3. The method of claim 1, wherein users of at least some devices of the plurality of devices are archeologists operating within an area in which the wireless communication network is inoperable.

4. The method of claim 1, wherein users of at least some devices of the plurality of devices are soldiers operating within an area in which the wireless communication network is inoperable.

5. The method of claim 1, wherein the second device includes the application and the method further comprises:
establishing, by the application on the second device, a second communication link with a third device of the plurality of devices, wherein the third device is configured to operate within the wireless communication network, and wherein the second communication link is a direct communication link between the second device and the third device; and
forwarding, by the application, the communication signal over the second communication link from the second device to the third device.

6. The method of claim 1, wherein the communication signal comprises data from a sensor coupled to the first device.

7. The method of claim 1, wherein the communication signal is a voice signal.

8. The method of claim 1, wherein the communication signal is a text signal.

9. An apparatus comprising:
one or more processors; and
a non-transitory storage medium comprising instructions stored thereon, the instructions being executable by the one or more processors to cause the one or more processors to perform one or more actions comprising:
determining, by an application on at least a first device of a plurality of devices, a geographical location that includes the plurality of devices, wherein each of the plurality of devices is configured to operate within a wireless communication network;
based at least in part on the geographical location, defining, by the application, a local area network (LAN) of the plurality of devices, wherein the LAN provides direct communication links among at least some of the plurality of devices;
establishing, by the application, a first communication link between the first device and a second device of the plurality of devices, wherein the first device and the second device are configured to operate within the wireless communication network, and wherein the first communication link is a direct communication link between the first device and the second device; and
sending, by the application, a communication signal over the first communication link from the first device to the second device.

10. The apparatus of claim 9, wherein users of at least some devices of the plurality of devices are part of a search and rescue team operating within an area in which the wireless communication network is inoperable.

11. The apparatus of claim 9, wherein users of at least some devices of the plurality of devices are archeologists operating within an area in which the wireless communication network is inoperable.

12. The apparatus of claim 9, wherein users of at least some devices of the plurality of devices are soldiers operating within an area in which the wireless communication network is inoperable.

13. The apparatus of claim 9, wherein the second device includes the application and the one or more actions further comprise:
establishing, by the application on the second device, a second communication link with a third device of the plurality of devices, wherein the third device is configured to operate within the wireless communication network, and wherein the second communication link is a direct communication link between the second device and the third device; and
forwarding, by the application, the communication signal over the second communication link from the second device to the third device.

14. The apparatus of claim 9, wherein the communication signal comprises data from a sensor coupled to the first device.

15. The apparatus of claim 9, wherein the communication signal is a voice signal.

16. The apparatus of claim 9, wherein the communication signal is a text signal.

17. One or more non-transitory storage media comprising instructions stored thereon, the instructions being executable by one or more processors to perform actions comprising:
determining, by an application on at least a first device of a plurality of devices, a geographical location that includes the plurality of devices, wherein each of the plurality of devices is configured to operate within a wireless communication network;
based at least in part on the geographical location, defining, by the application, a local area network (LAN) of the plurality of devices, wherein the LAN provides direct communication links among at least some of the plurality of devices;
establishing, by the application, a first communication link between the first device and a second device of the plurality of devices, wherein the first device and the second device are configured to operate within the wireless communication network, and wherein the first communication link is a direct communication link between the first device and the second device; and
sending, by the application, a communication signal over the first communication link from the first device to the second device.

18. The one or more non-transitory storage media of claim 17, wherein users of at least some devices of the plurality of devices are part of a search and rescue team operating within an area in which the wireless communication network is inoperable.

19. The one or more non-transitory storage media of claim 17, wherein users of at least some devices of the plurality of devices are soldiers operating within an area in which the wireless communication network is inoperable.

20. The one or more non-transitory storage media of claim 17, wherein the second device includes the application and the actions further comprise:
establishing, by the application on the second device, a second communication link with a third device of the plurality of devices, wherein the third device is configured to operate within the wireless communication network, and wherein the second communication link is a direct communication link between the second device and the third device; and
forwarding, by the application, the communication signal over the second communication link from the second device to the third device.
